(19) United States
(12) Patent Application Publication
(10) Pub. No.: US 2018/0345751 A1
(43) Pub. Date: Dec. 6, 2018

(54) HVAC SYSTEM

(71) Applicants: DENSO International America, Inc., Southfield, MI (US); DENSO CORPORATION, Kariya-city (JP)

(72) Inventors: Prakash THAWANI, Bloomfield Hills, MI (US); Stephen SINADINOS, Commerce Township, MI (US)

(21) Appl. No.: 15/613,846

(22) Filed: Jun. 5, 2017

(51) Int. Cl. B60H 1/00

(52) U.S. Cl. CPC B60H 1/00021; B60H 1/00814; B60H 2001/3282; B60H 2001/002; B60H 2001/00114

(57) ABSTRACT

A heating, ventilation, and air conditioning (HVAC) system including front and rear blowers. The front blower blows air through a front evaporator to a front area of a passenger cabin. The rear blower blows air through the front evaporator in an integrated HVAC system or through a rear evaporator, and to a rear area of the passenger cabin. The rear blower is always active when the front blower and air conditioning is active.

### FIELD

The present disclosure relates to a heating, ventilation, and air conditioning (HVAC) system, such as a vehicle HVAC system.

### BACKGROUND

This section provides background information related to the present disclosure, which is not necessarily prior art.

Dual or integrated vehicle heating, ventilation, and air conditioning systems (HVAC) include multiple blowers, typically a front blower for a front area of the passenger cabin and a rear blower for a rear area of the passenger cabin. Existing dual/integrated HVAC systems undesirably produce hiss and gurgle sounds, particularly when the front blower is on and the rear blower is off. This phenomena occurs primarily due to lack of sub-cooling and lower background noise in the passenger cabin as a result of the rear blower being deactivated. In addition, it will be more pronounced/amplified and become readily audible in EV, HEV, and gasoline vehicles equipped with idle stop/start technology. The present teachings advantageously provide for an improved dual/integrated vehicle HVAC system with suppressed audibility of evaporator hiss/gurgle.

### SUMMARY

This section provides a general summary of the disclosure, and is not a comprehensive disclosure of its full scope or all of its features.

The present teachings provide for a heating, ventilation, and air conditioning (HVAC) system including front and rear blowers. The front blower blows air through a front evaporator to a front area of a passenger cabin. The rear blower blows air through the front evaporator in an integrated HVAC system or through a rear evaporator, and to a rear area of the passenger cabin. The rear blower is configured to be always active when the front blower and air conditioning is active.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of select embodiments and not all possible implementations, and are not intended to limit the scope of the present disclosure.

FIG. 1 illustrates a heating, ventilation, and integrated air conditioning (HVAC) system in accordance with the present teachings; and

FIG. 2 illustrates another heating, ventilation, and air conditioning (HVAC) system in accordance with the present teachings.

Corresponding reference numerals indicate corresponding parts throughout the several views of the drawings.

### DETAILED DESCRIPTION

Example embodiments will now be described more fully with reference to the accompanying drawings.

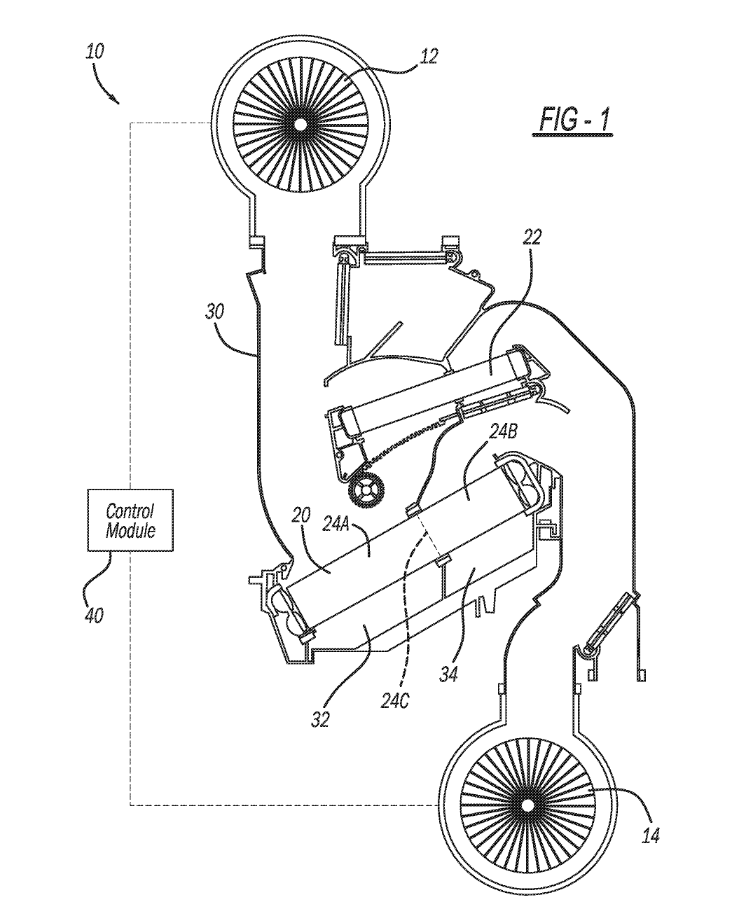

With initial reference to FIG. 1, an integrated heating, ventilation, and air conditioning system in accordance with the present teachings is illustrated at reference numeral 10. The HVAC system 10 can be used with any suitable vehicle in which it is desirable to include multiple HVAC blowers to direct air to both a front portion and a rear portion of a passenger cabin. The HVAC system 10 can be used with any suitable passenger vehicle (e.g., sedan, station wagon, van, minivan, sport utility vehicle, limousine, etc.), mass transit vehicle, military vehicle, aircraft, etc. The HVAC system 10 can also be used with any suitable non-vehicular application.

The HVAC system 10 generally includes a front blower 12 and a rear blower 14. The front blower 12 can be any suitable airflow generating device configured to direct airflow to a front area of a vehicle passenger cabin. The rear blower 14 can be any suitable device for generating and directing airflow to a rear area of the vehicle passenger cabin.

The HVAC system 10 further includes an evaporator 20. The front blower 12 and the rear blower 14 are both arranged to direct airflow through the evaporator 20 in the integrated HVAC example illustrated in FIG. 1. The HVAC system 10 may also include a heater core 22, and the blowers 12 and 14 may be arranged to direct airflow through the heater core 22 as well. The evaporator 20 and the heater core 22 are arranged in a case 30, which includes a front outlet 32 and a rear outlet 34. The front outlet 32 directs airflow to the front area of the vehicle passenger cabin, and the rear outlet 34 directs airflow to the rear area of the vehicle passenger cabin. The case 30 is configured to direct airflow generated by the front blower 12 through a front portion 24A of the evaporator 20. The case 30 is configured to direct airflow generated by the rear blower 14 through a rear portion 24B of the evaporator 20. The front portion 24A and the rear portion 24B are separated by any suitable partition 24C. The front portion 24A is typically larger than the rear portion 24B. For example, the front portion 24A can be 60% of, or about 60% of, the evaporator 20, and the rear portion 24B can be 40% of, or about 40% of, the evaporator 20.

The HVAC system 10 further includes a control module 40. In this application, including the definitions below, the term “control module” may be replaced with the term “circuit.” “Control module” may refer to, be part of, or include processor hardware (shared, dedicated, or group) that executes code and memory hardware (shared, dedicated, or group) that stores code executed by the processor hardware. The code is configured to provide the features of the control module and systems described herein. The term memory hardware is a subset of the term computer-readable medium. The term computer-readable medium, as used herein, does not encompass transitory electrical or electromagnetic signals propagating through a medium (such as on a carrier wave). The term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The control module 40 controls activation, deactivation, and speed of the front blower 12 and the rear blower 14. The control module 40 can also control activation and deactivation of the evaporator 20 and the heater core 22. The control module 40 activates the rear blower 14 when the front blower 12 and the evaporator 20 are active. Thus, the rear blower 14 will always be active when the front blower 12 and the evaporator 20 are active. The rear blower 14 can be operated at any suitable speed, such as at least a low speed. For example, when a user requests activation of the front blower 12 and the evaporator 20 to cool the front area of the vehicle passenger cabin, such as by entering a command using any suitable user interface (e.g., an electronic interface such as an instrument panel touch screen, or a mechanical interface such as a switch or knob) the control module 40 will sense such activation and automatically activate the rear blower 14 at least at a low speed. In this manner, the control module 40 advantageously ensures that the rear blower 14 is always in operation when the front blower 12 is activated with air conditioning on.

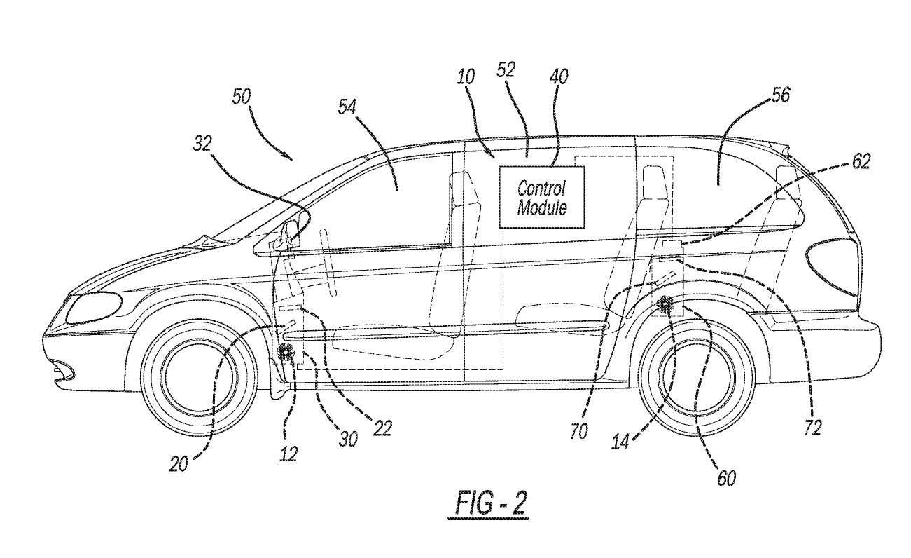

FIG. 1 illustrates the HVAC system 10 as an integrated HVAC system in which both the front blower 12 and the rear blower 14 direct airflow through the same evaporator 20. The present teachings are also applicable to dual HVAC systems, such as the dual HVAC system of FIG. 2. FIG. 2 illustrates the dual HVAC system installed in an exemplary vehicle 50. The vehicle 50 can include the illustrated dual HVAC system, or the integrated HVAC system of FIG. 1 instead of the illustrated dual HVAC system. In applications where the vehicle 50 includes the integrated HVAC system of FIG. 1, the rear case 60 (and the contents thereof) will not be included, and the integrated case 30 of FIG. 1 will be included instead of the dual case 30 of FIG. 2.

FIG. 2 illustrates the exemplary vehicle 50 including the HVAC system 10 according to the present teachings configured as a dual HVAC system. The dual HVAC system of FIG. 2 conditions the air of passenger cabin 52, and specifically both a front area 54 and a rear area 56 of the passenger cabin 52. The case 30 and the front blower 12 are arranged proximate to the front area 54. The front blower 12 is configured to direct air through the evaporator 20, and to the front area 54 of the passenger cabin 52 through the front outlet 32.

The dual HVAC system of FIG. 2 further includes a rear case 60 housing a rear evaporator 70. The rear blower 14 is housed within, or associated with, the rear case 60, and is arranged to generate airflow that passes through the evaporator 70. Airflow exits the case 60 through rear outlet 62, and flows to the rear area 56 to condition air in the rear area 56 of the vehicle 50. The rear case 60 may also include a heater core 72.

The control module 40 is configured to activate the rear blower 14 in a manner described above, so that whenever the front blower 12 is in operation with the air conditioning on, the rear blower 14 will also be in operation at any suitable low blower speed, such as at the lowest blower speed. Thus, the control module 40 activates the rear blower 14 whenever the front blower 12 is activated. As a result, the rear blower 14 advantageously suppresses the audibility of the hiss/gurgle generated by the front and/or rear evaporators 20 and 70 due to optimized sub-cooling and slightly increased background noise due to both the blowers 12 and 14 operating simultaneously. As a result, occupants of the passenger cabin 52 will not be subject to any undesirable hiss/gurgle noises produced by the front and/or rear evaporators 20 and 70.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A heating, ventilation, and air conditioning (HVAC) system comprising:
a front blower for blowing air to a front area of a vehicle passenger cabin;
a rear blower for blowing air to a rear area of the vehicle passenger cabin; and
a control module that activates the rear blower when the front blower is activated with air conditioning on such that the rear blower is always active when the front blower is active.

2. The HVAC system of claim 1, wherein the HVAC system is an integrated HVAC system including a single evaporator that receives airflow from both the front blower and the rear blower.

3. The HVAC system of claim 2, wherein the single evaporator is housed within a case, the case including a heater core.

4. The HVAC system of claim 3, wherein the case includes a front outlet directing airflow generated by the front blower to a front of the vehicle, and a rear outlet directing airflow generated by the rear blower to a rear of the vehicle.

5. The HVAC system of claim 4, wherein 60% of the evaporator receives airflow from the front blower, and 40% of the evaporator receives airflow from the rear blower.

6. The HVAC system of claim 1, wherein the HVAC system is a dual HVAC system including a front evaporator in receipt of airflow generated by the front blower, and a rear evaporator in receipt of airflow generated by the rear blower.

7. The HVAC system of claim 1, wherein the control module activates the rear blower at a low blower speed when the front blower is activated with air conditioning activated.

8. A heating, ventilation, and air conditioning (HVAC) system comprising:
a front blower for blowing air through a front evaporator and to a front area of a passenger cabin; and
a rear blower for blowing air through one of the front evaporator and a rear evaporator, and to a rear area of the passenger cabin;
wherein the rear blower is always active when the front blower is active with air conditioning on.

9. The HVAC system of claim 8, further comprising an HVAC case including the front evaporator and a heater.

10. The HVAC system of claim 9, wherein the case includes a front outlet directing airflow generated by the front blower to the front area of the vehicle, and a rear outlet directing airflow generated by the rear blower to the rear area of the vehicle.

11. The HVAC system of claim 8, further comprising a controller configured to activate the rear blower when the front blower is activated with air conditioning on.

12. The HVAC system of claim 11, wherein the controller is configured to activate the rear blower at a low speed.

13. The HVAC system of claim 8, wherein the rear blower blows air through the rear evaporator arranged in a rear case that is separate from a front case including the front evaporator.

14. The HVAC system of claim 8, further comprising a controller configured to activate the rear blower when a user inputs a command for activating the front blower with air conditioning on.
